(19) United States
(12) Patent Application Publication
(10) Pub. No.: US 2002/0124246 A1
(43) Pub. Date: Sep. 5, 2002

(54) Methods, systems and program products for tracking information distribution

(76) Inventors: David Louis Kaminsky, Chapel Hill, NC (US); David Mark Ogle, Cary, NC (US)

Correspondence Address: David Louis Kaminsky, 103 Corbin Hill Circle, Chapel Hill, NC, 27514, US

(21) Appl. No.: 10/084,572

(22) Filed: Feb. 27, 2002

Related U.S. Application Data
(60) Provisional application No. 60/272,599, filed on Mar. 2, 2001.

(51) Int. Cl. H04N 7/16; H04H 9/00; G06F 3/00; H04N 5/445; G06F 13/00; H04N 7/173

(52) U.S. Cl. 725/9; 725/46; 725/112

(57) ABSTRACT

Methods, systems and program products for tracking the distribution of information (e.g., television programming) to viewers. Tracking is accomplished by inserting a tracking identifier within the information. When a client (e.g., a television set top box) receives the content, it extracts the tracking identifier, and transmits the identifier to a server. When the server receives the tracking identifier, it records the tracking identifier on a storage device for analysis. In one embodiment, the information includes television programs, and the tracking identifier is transmitted in the programs' blanking intervals.

### PRIORITY APPLICATION INFORMATION

This application claims the benefit of United States Provisional Patent Application 60/272,599, filed Mar. 2, 2001, the disclosure of which is incorporated herein by reference in its entirety.

### FIELD OF THE INVENTION

The present invention relates generally to techniques for tracking information distribution and, more specifically, to techniques allowing such tracking to occur automatically and without the need for sampling.

### BACKGROUND OF THE INVENTION

Some content creators derive revenue by selling access to their content. For example “pay-per-view” television programs generate revenue when viewers directly purchase the programs. In other cases, content creators derive revenue indirectly when the content is viewed. For example, television networks sell advertisements that run during programs, and the fee the network is willing to pay for a program is related to the amount of revenue they can derive from the advertisements that run during the program. The advertising fees are, in turn, related to the number of viewers who watch the program. Thus, the value of a television program is related to the number of viewers. Similarly, the value to an advertiser of a particular advertisement is related to the number of consumers exposed to that advertisement. In these scenarios, two types of parties are interested in viewer exposure: the content creators (both program and advertisement) and the media intermediary (e.g., the television networks).

Such media intermediaries aggregate content from a number of creators, and deliver that content to consumers. For example, broadcast and cable television networks purchase television programs from production companies. Similarly, advertisements are obtained from advertisers and inserted into television programs. Media intermediaries are interested in the viewing patterns of all of the content that they transmit, as such patterns dictate their revenue opportunities and their costs. Thus, there is value both to information producers and to media intermediaries in learning viewing patterns of the content (including programs and advertisements).

Most television advertisements uses the Industry Standard Coding Identification (ISCI) standard administered by the American Association of Advertising Agencies (AAAA, New York, N.Y.) to tag advertisements. Television advertisements typically carry an ISCI code as a physical marking, for example, affixed to the outside of the media. When a broadcaster runs an advertisement, the broadcaster can report information about the broadcast to the supplier of the advertisement according to the ISCI code. Most broadcasters lack an automatic reporting system for ISCI codes, and no system reports on the viewing of advertisements organized by ISCI code—that is, there is no mechanism for viewers to report (automatically or by hand) directly that an advertisement carrying an ISCI code reached their television.

There are systems that can measure viewing of television programs. For example, the Nielsen ratings (Nielsen Media Research, New York, N.Y.) measure viewing patterns of television programming by using measurement equipment located in viewers' households. Such equipment measures what viewers watch by detecting what channel a viewer is watching at each time period, and transmits that information (time, channel and other relevant information) to a central station for analysis. Using these measurements, Nielsen attempts to learn television-viewing patterns of the target households, and to extrapolate overall behavior patterns. Further extrapolation is done to determine how often an advertisement is viewed.

One drawback to such systems is that they measure program viewing indirectly—that is, they measures time and channel, and must later correlate that data with the actual programs viewed. Because of the complexity of such correlation, typically only a subset of viewing activity is monitored. For example, while Nielsen Media tracks program viewing, it does not monitor advertisement viewing. Rather, that information is extrapolated from the viewing records. However, such extrapolation is inaccurate since local broadcasters can choose to override some commercials, so accurate correlation would require the time, the channel, the location and the broadcaster. Such complexity greatly limits the ability to perform such correlation. Thus, such indirect measurements do not yield a complete picture of information consumption.

Instead of using time/channel measurement equipment, some media outlets employ surveys to determine viewer behavior. In some cases, they will call representative households to determine what content was accessed. However, such systems are not completely accurate, as they do not measure all content-access patterns (e.g., they still must correlate program viewing with commercial viewing), and they rely on people's memories. In addition, such a technique measures viewing of composite information rather than viewing of subcomponents.

From the preceding description, it is apparent that systems are needed to better measure such content-access patterns. Ideally such systems would not rely on indirect measurements nor would they rely on human recollection.

As additional background, there has been a rapid growth in networked computer systems, particularly those providing an end user with an interactive user interface. An example of an interactive computer network is the World Wide Web (hereafter, the “web”). The web is a facility that overlays the Internet and allows end users to browse web pages using a software application known as a web browser or, simply, a “browser.” Exemplary browsers include Internet Explorer by Microsoft Corporation of Redmond, Wash., and Netscape Navigator by Netscape Communications Corporation of Mountain View, Calif. For ease of use, a browser includes a graphical user interface that it employs to display the content of “web pages.” Web pages are formatted, tree-structured repositories of information. Their content can range from simple text materials to elaborate multimedia presentations.

The web is generally a client-server based computer network. The network includes a number of computers (i.e., “servers”) connected to the Internet. The web pages that an end user will access typically reside on these servers. An end user operating a web browser is a “client” that, via the Internet, transmits a request to a server to access information available on a specific web page identified by a specific address. This specific address is known as the Uniform Resource Locator (“URL”). In response to the end user's request, the server housing the specific web page will transmit (i.e., “download”) a copy of that web page to the end user's web browser for display.

To ensure proper routing of messages between the server and the intended client, the messages are first broken up into data packets. Each data packet receives a destination address according to a protocol. The data packets are reassembled upon receipt by the target computer. Commonly accepted protocols for this purpose are the Internet Protocol (hereafter, “IP”) and Transmission Control Protocol (hereafter, “TCP”), though other protocols may be used. IP dictates routing information. TCP dictates how messages are actually separated in to IP packets for transmission for their subsequent collection and reassembly. TCP/IP connections are typically employed to move data across the Internet, regardless of the medium actually used in transmitting the signals.

Any Internet “node” can access a specific web page by invoking the proper communication protocol and specifying the URL. (A “node” is a computer with an IP address, such as a server permanently and continuously connected to the Internet, or a client that has established a connection to a server and received a temporary IP address.) Typically, the URL has the format http://<host>/<path>, where “http” refers to the HyperText Transfer Protocol, “host” is the server's Internet identifier, and the “path” specifies the location of a file (e.g., the specific web page) within the server.

The emergence of the Internet has inspired companies to offer other interactive experiences. For example, many television systems now come equipped with the ability not only to receive programming, but also to transmit data back to the television provider, for example, by using a cable modem. Many pay-per-view systems offered by cable companies use such an “upstream” communications channel to enable viewers to order programs.

The upstream and downstream communications channels use a networking protocol to transmit data. Such channels can use TCP/IP as described above, or an alternative protocol to accomplish the same end.

As additional background, the patent literature describes some related, yet distinct technologies.

U.S. Pat. No. 4,025,851 issued March 1977 describes a mechanism for identifying a program using time-varying codes, and periodically transmitting those codes to a central server that can then monitor which program is being viewed. However, the receipt of the program does not automatically trigger an event that causes the information to be transmitted to a central server. Therefore, since events are not transmitted immediately, real-time monitoring of program viewership is impossible.

U.S. Pat. No. 4,230,990 issued October 1980 describes a mechanism for detecting or inferring a code and comparing that information to a list of know programs to determine what program is being viewed.

U.S. Pat. No. 4,639,779 issued January 1987 describes the transmission of programming with an ID encoded on each frame. However, it does not describe any mechanism for tracking viewership using this code.

U.S. Pat. No. 4,857,999 issued August 1989 describes a mechanism for identifying advertisements by comparing information encoded in the Vertical Blanking Interval (VBI) against a database of known advertisements. However, it does not describe a mechanism for real-time tracking of such information

U.S. Pat. No. 4,967,273 issued in October 1990 tracks the flow of television programming, but requires the generation of a channel identification system. Thus, it does not leverage a code embedded in the signal.

U.S. Pat. No. 5,450,122 issued September 1995 describes a program tracking system in which a code is inserted in programming, and detected at the broadcaster when it's broadcast. However, it does not describe any mechanism for tracking viewership.

U.S. Pat. No. 5,457,807 issued October 1995 describes a technique for surveying a radio or a television audience in which an audio signal contains sub-signal that is detected by monitor on a listener's body that uses the signal to track what stations a user listens to. However, it describes the station, not the program being viewed (listened to).

U.S. Pat. No. 5,481,294 issued January 1996 describes a system in which an encoded program is detected by receiver using both encoded IDs if present and video recognition if not. However, this system requires a household ID; describes no means to transmit signal; and needs program and reference signal.

U.S. Pat. No. 5,532,732 issued July 1996 describes a system in which the time and channel are encoded in programming. However, it describes no mechanism for using an identifier pre-encoded in a program, nor a mechanism for automatically transmitting the code to a monitoring station.

U.S. Pat. No. 5,818,441 issued October 1998 describes encoding URLs in video, but required a one-way network.

U.S. Pat. No. 5,850,249 issued December 1998 describes a process for inserting a local code into a stream so the system knows where the program came from, then tracks and transmit the code. However, the process requires a “storing means” at the local site and requires a time stamp.

U.S. Pat. No. 5,961,603 issued in October 1999 describes encoding URLs in programs, but does not describe a mechanism for tracking program viewership using this URL.

U.S. Pat. No. 6,018,768 issued January 2000 describes a system in which URLs are embedded in broadcasts allow users to view content. However, it does not describe a system in which viewers are tracked.

U.S. Pat. No. 6,058,430 issued May 2000 describes a technique for embedding a URL in the VBI. However, it does not describe a mechanism for using such a URL for tracking program viewership.

In summary, the existing patent art describe in great detail mechanisms for tracking program viewership, encoding URLs in a video stream, encoding information in the VBI, and even encoding URLs in the VBI. However, the use of URLs (or similar mechanism) encoded in a program transmission stream and automatically transmitted to a monitoring station is neither described directly, nor suggested by the existing patent art.

### SUMMARY OF THE INVENTION

The present invention provides a way to measure content-access patterns directly and requires no viewer interaction.

One embodiment of the invention features a method of measuring access patterns of content transmitted from a server to a client. (We use the terms “information” and “content” interchangeably.) A server accepts information from a content producer. Such information can be encoded using either analog or digital encoding. The server then creates a tracking identifier and inserts the tracking identifier into the information. Typically, the tracking identifier comprises a URL. The server then transmits the information augmented with the tracking identifier to a client.

The client receives the augmented information and isolates the tracking identifier. It then transmits the tracking identifier to a server, where the tracking identifier, along with optional data such as time of day, identification of viewer, date and geographic location is recorded for analysis. Typically, the client will also display the information to a viewer.

In a related embodiment, the invention provides an article of manufacture that includes a program storage medium having computer readable program code for causing a client to provide a tracking identifier to a server. The computer readable program code causes a computer to accept the information with the tracking identifier, isolate the tracking identifier, and transmit the tracking identifier from the client to the server. In a different embodiment, a program storage medium tangibly embodies a program of instructions executable by the computer to perform the corresponding method steps for the aforementioned delivery of a tracking identifier to a server.

In another embodiment, the aforementioned information received by the server is a television broadcast signal comprising a series of video “lines” and a “vertical blanking interval” containing data that is not displayed to a viewer. When the tracking identifier is inserted in the information (in this embodiment, a television signal), the tracking identifier is inserted in the vertical blanking interval of the television signal. Optionally, the tracking identifier can be inserted into the vertical blanking interval according to the ATVEF (Advanced Television Enhancement Forum) or equivalent standard.

In a related embodiment, the invention provides an article of manufacture that includes a program storage medium having computer readable program code for a server to insert a tracking identifier into the vertical blanking interval of a television signal. In a different embodiment, a program storage medium tangibly embodies a program of instructions executable by the computer to perform the corresponding method steps for the aforementioned delivery of a tracking identifier to a server.

In another embodiment, the information is a television advertisement, and the tracking identifier comprises as ISCI code assigned to the advertisement. Optionally, the tracking identifier is inserted into the blanking interval of the advertisement's data stream. The client extracts the ISCI code and transmits it to the server. Once logged on the server, the tracking identifier comprising the ISCI code can be correlated with other information indexed by the ISCI code.

In a related embodiment, the invention provides an article of manufacture that includes a program storage medium having computer readable program code for a server to insert a tracking identifier comprising an ISCI code. Optionally, the code is inserted into the vertical blanking interval of a television signal. In a different embodiment, a program storage medium tangibly embodies a program of instructions executable by the computer to perform the corresponding method steps for the aforementioned insertion.

In yet another embodiment, when the client receives the aforementioned augmented information, it isolates the tracking identifier, and constructs a URL comprising the tracking identifier. The client then transmits the URL to the server. On the server, a web server program is executing and accepts the requested URL, entering the request in a log file.

In a related embodiment, the invention provides an article of manufacture that includes a program storage medium having computer readable program code for a web server to accept URLs that include tracking identifiers and record the URLs with tracking identifiers in the web server's log file. In a different embodiment, a program storage medium tangibly embodies a program of instructions executable by the computer to perform the corresponding method steps for the aforementioned delivery of tracking identifiers to a server.

Other aspects and advantages of the present invention will become apparent from the following detailed description that, taken in conjunction with the accompanying drawings, illustrate the principles of the invention by way of example only.

### BRIEF DESCRIPTION OF THE DRAWINGS

The foregoing and other objects, features, and advantages of the present invention, as well as the invention itself, will be more fully understood from the following description of various embodiments, when read together with the accompanying drawings, in which:

FIG. 1 is a schematic view of a hardware and software system constructed in accordance with an embodiment of the invention;

FIG. 2 depicts pseudo-code for an embodiment of the invention; and

FIG. 3 is a workflow diagram showing an embodiment of the general operation of the invention.

FIG. 4 is a workflow diagram showing an embodiment of a specific instance of operation of the invention.

### DETAILED DESCRIPTION OF THE INVENTION

As shown in the drawings for the purposes of illustration, the invention may be embodied in a method of automatically measuring the distribution of information transmitted over a network. A system according to the invention efficiently provides highly accurate measurements of such information. This invention avoids the need to build an extensive infrastructure to accomplish such measurements.

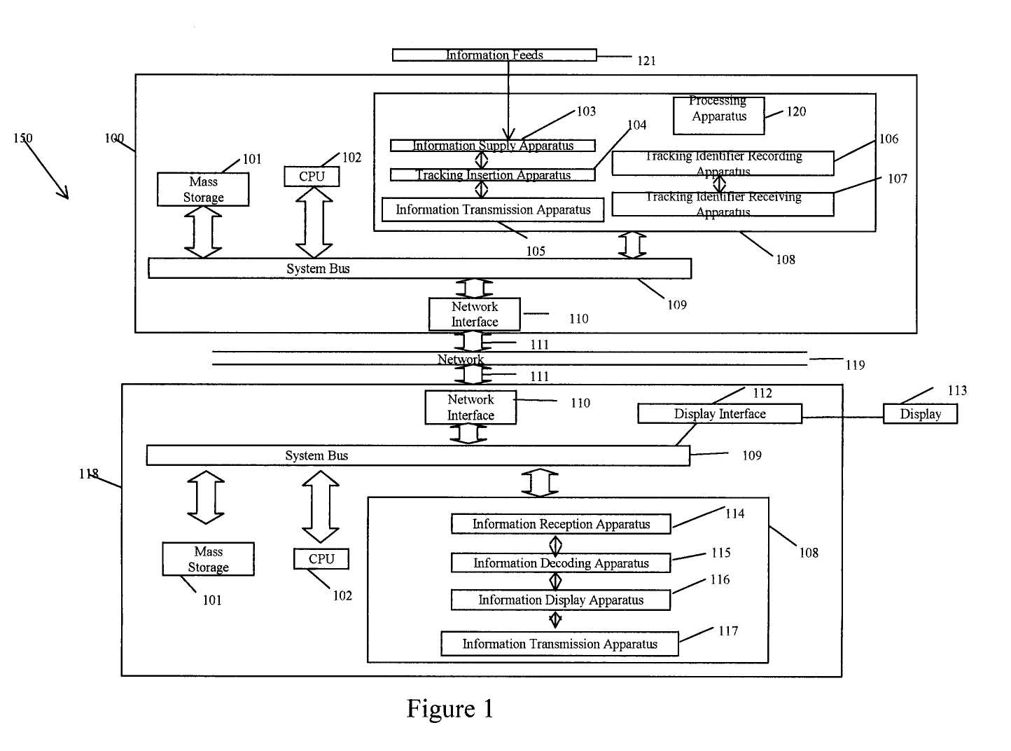

FIG. 1 shows a representative client-server implementation of the invention 150 that includes a server 100 and a client 118, which communicate over a network such as the Internet 119. In one embodiment, the components of server 100 intercommunicate over a main bi-directional system bus 109. The main sequence of instructions effectuating the invention resides on a mass storage device (such as a hard disk or optical storage unit) 101 as well as in a main system memory 108 during operation. Execution of these instructions and effectuation of some of the functions of the invention is accomplished by a central processing unit (“CPU” ) 102. Within the server 100, a network interface 110 is connected to the main bidirectional system bus 109. The server 100 is connected to a network such as the Internet 119 via the network interface 110 and a server connection 111.

The executable instructions that control the operation of the CPU 102 and thereby effectuate the functions of the invention are conceptually depicted as a series of interacting modules resident within the memory 108. (Not shown is the operating system that directs the execution of low-level, basic system functions such as memory allocation, file management and operation of the mass storage devices 101.) As is well understood in the art, communication over networks such as the Internet 119 is accomplished by encoding information to be transferred into data packets. Each packet receives a destination address according to a consistent protocol, and each is reassembled upon receipt by the target computer. A commonly accepted set of protocols for this purpose includes the aforementioned Internet Protocol (“IP”) and the Transmission Control Protocol (“TCP”). The Internet supports a large variety of information-transfer protocols, and the web represents one of these. The client 118 is composed similarly.

An Information Supply Apparatus 103 is responsible for supplying the information that will be transmitted from the server 100 to the client 118. In one embodiment, such information is a video stream encoded using the NTSC or a similar standard. NTSC stands for National Television System Committee, which devised the NTSC television broadcast system in 1953. The NTSC standard has a fixed vertical resolution of 525 horizontal lines stacked on top of each other, with varying amounts of “lines” making up the horizontal resolution, depending on the electronics and formats involved. There are 59.94 fields displayed per second. A field is a set of even lines, or odd lines. The odd and even fields are displayed sequentially, thus interlacing the full frame. One full frame, therefore, is made of two interlaced fields, and is displayed about every 1/30 of a second. (http://www.ncsa.uiuc.edu/SCMS/training/general/details/ntsc.html) This apparatus 103 can obtain the content from a variety of information feeds 121, including “feeds” from television networks. Alternative information formats such as audio and web content can also be used, as can alternative coding standards, without materially effecting this invention. Similarly, the content can be encoded either using an analog or digital encoding.

The Information Supply Apparatus 103 treats each component of information discretely. So, for example, when an advertisement is transmitted within a television program, the Information Supply Apparatus 103 transmits the first segment of the program followed by the advertisement, which is treated as a separate unit from the program. Any subsequent advertisements are also sent discretely. When the program resumes after the advertisement(s), the next segment of the program is transmitted.

The Tracking Insertion Apparatus 104 inserts a tracking identifier into the information stream. The tracking identifier comprises a set of data (such as an integer identifier) that identifies the information being transmitted. It can optionally include a timestamp and other identifiers that further identify the content. In one embodiment, the tracking identifier comprises a Uniform Resource Locator (URL) containing an identifying element that is inserted by the Tracking Insertion Apparatus into the NTSC stream according to the Advanced Television Enhanced Format (ATVEF) specification, included herein by reference. ATVEF defines how URLs are inserted into video streams. Specifically, it specifies that such URLs be inserted into the “vertical blanking interval” (VBI) line 21. This technique closely resembles the well-known broadcast technique of embedding “Closed Captioning” in television programming. In a related embodiment, the tracking identifier comprises an ISCI code identifying programming, typically a television commercial.

The Tracking Insertion Apparatus 104 can generate tracking identifiers (e.g., by assigning numerical identifiers serially), it can accept the tracking identifiers from an external source, or it can accept or compute the tracking identifiers algorithmically from the information itself.

In one embodiment, when the tracking identifier comprises a URL, consider the case where the server is located at “XYZ.com”, and the information identifier is 1234. Such as URL comprising a tracking identifier might be: http://www.XYZ.com/1234.

The Information Transmission Apparatus 105 uses the system bus 109 to transmit the tracking identifier to the network interface 110, which further transmits the information across a network 119 to the client 118.

On the client, the Information Reception Apparatus 114 uses the network interface 110 and the system bus 109 to obtain the information transmitted from the server.

While the information typically flows directly from the server 100 to the client 118 by way of the network 111, in some cases, intermediate components might intervene. For example, a recording device (not shown) co-located with the server or client, or operating as a standalone device, might record the information, and later retransmit the information. Such an intervening mechanism will not materially effect this invention.

The Information Decoding Apparatus 115 receives the signal from the Information Reception Apparatus 114, and extracts the tracking identifier from the signal. Since the Tracking Insertion Apparatus 104 encoded the tracking identifier using a known technique (such as ATVEF), the Information Decoding Apparatus 115 can locate and extract that information.

The client's Information Transmission Apparatus 117 receives the decoded tracking identifier from the Information Decoding Apparatus 115 and transmits the tracking identifier back to the server 100. The Information Transmission Apparatus 117 uses the system bus 109 and the network interface 110 to send the tracking identifier comprising a URL over the network 119.

In one embodiment, as discussed above, the tracking identifier is encoded in an NTSC video signal according to the ATVEF standard. In this case, the Information Decoding Apparatus 115 extracts the tracking identifier from the VBI. The tracking identifier comprises a URL. The Information Transmission Apparatus 117 transmits this URL over the network 119, in this case, the Internet, to the server 100. Optionally, the Information Decoding Apparatus 115 can include auxiliary information such as viewer identifier or an indicator of geographic location.

Optionally, the Information Display Apparatus 116 can transmit the remaining information signal over the system bus 109 to a display interface 112, which shows the information on a display device 113, such as a standard television.

The Tracking Identifier Receiving Apparatus 107 accepts the transmission from the Information Transmission Apparatus 117. In one embodiment, a web server software module operating on the server 100 allows the server act as a web site, thereby conferring the capability of accepting URLs transmitted over the Internet. When the client's Information Transmission Apparatus 117 transmits the tracking identifier over the Internet, the web server acting as Tracking Identifier Receiving Apparatus 107 can accept that information.

The Tracking Identifier Recording Apparatus 106 accepts the information from the Tracking Identifier Receiving Apparatus 107. The Tracking Identifier Recording Apparatus uses the system bus 109 to write the tracking identifier onto mass storage 101.

The Processing Apparatus 120 retrieves the tracking identifier using the system bus 109 from the mass storage device 101, performing appropriate analyses. For example, the Processing Apparatus 120 might compute the number of times a certain piece of information was accessed by clients. The Processing Apparatus 120 might, for example, make the analyses available as a web page.

In an embodiment of this invention, the web server software acting as the Tracking Identifier Receiving Apparatus 107 also contains a logging feature. (Standard web servers such as Apache from the Apache group include this function.) When the web server accepts the transmission, it automatically logs the transmission to a log file stored on mass storage 101. Thus, a web server can act as both the Tracking Identifier Receiving Apparatus 107 and the Tracking Identifier Recording Apparatus 106.

In an exemplary embodiment of this invention, the client 118 is contained within a television set-top box such as a Nokia Media Terminal (manufactured by Nokia Group, Finland) operatively connected to a network and to a television or an alternate display device.

The server 100 can be embodied in a standard server computer such as a Dell PowerEdge Tower Server running the Linux operating system and an Apache web server. One skilled in the art will recognize that these are standard hardware and software components and other components can be substituted without materially effecting this invention.

While FIG. 1 illustrates the components assigned either to a client or to a server, one skilled in the art will recognize that these components can be distributed across additional components provided that those components are operatively connected. Distributing the components does not materially effect this invention.

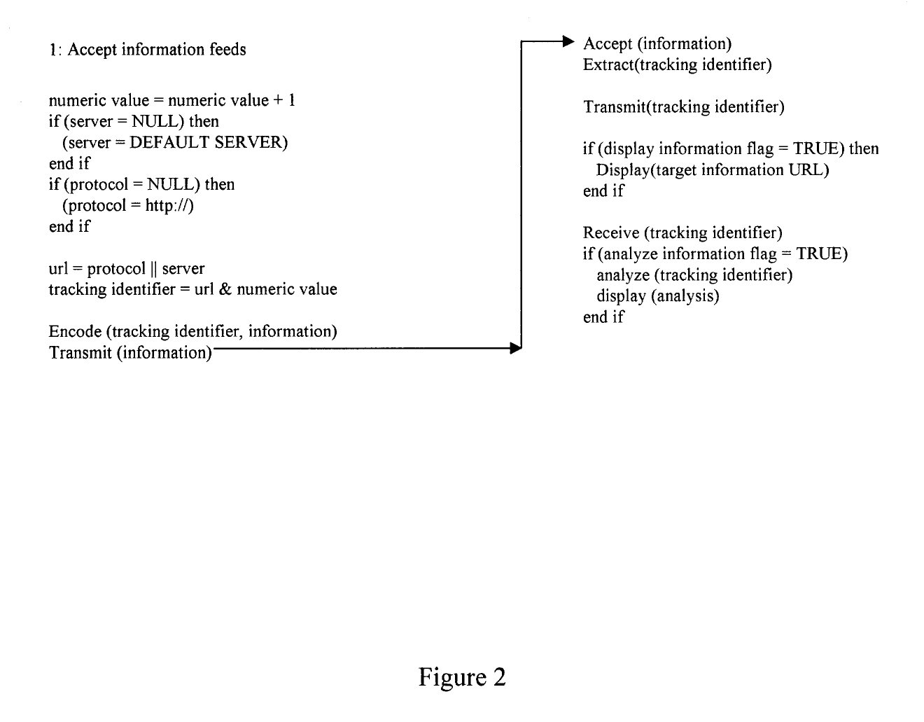

FIG. 2 depicts the invention is pseudo-code associated with one embodiment of the invention. The server accepts information feeds from an external source. It then computes the next numerical value to be used in the tracking identifier, and creates a URL containing both that numerical value and a pointer to the server also to be included in the tracking information. It inserts the tracking identifier into the accepted information according to its established standard, and transmits the information across the network to a client.

The client accepts the information, and extracts the tracking identifier from the information. It then transmits the tracking identifier across the network back to the server. It then optionally displays the information on a display device.

The server retrieves the tracking identifier from the network, and records the tracking identifier on a mass storage device. As the information is aggregated on the storage device, a component of the server optionally analyzes the data and makes such analyses available.

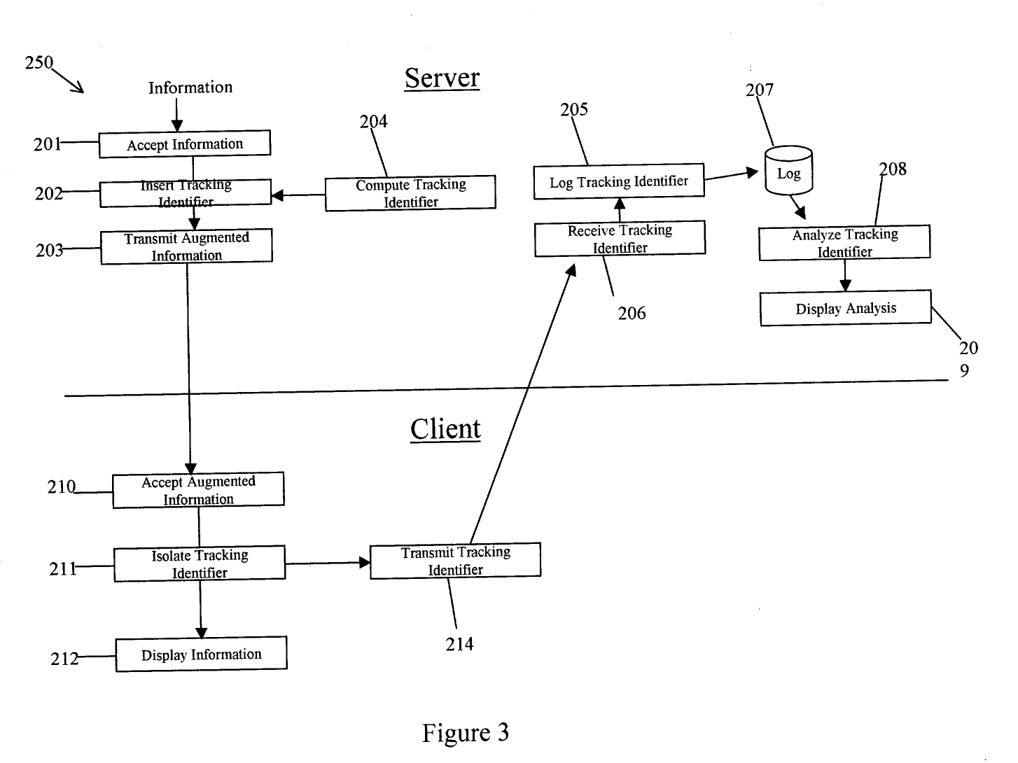

FIG. 3 shows a workflow diagram 250 that shows an embodiment of this invention. In greater detail, the server accepts information to be transmitted (step 201) to a client and displayed to an end user. When the information is received, a tracking identifier is generated (step 204). Typically, the tracking identifier is generated sequentially (1, 2, 3, etc.), although other techniques are acceptable. The information is augmented with the tracking identifier (step 202) and transmitted with the information (step 203) to the client.

The client accepts the augmented information (step 210), and isolates the tracking identifier (step 211). It then displays the original information on an appropriate display device (step 212). For example, video might be displayed on a television. It also transmits the tracking identifier to the server (step 214).

The server receives the tracking identifier (step 206), and logs the tracking identifier on a storage device (step 205).

The server optionally examines and analyzes the tracking identifier recorded on the storage device (step 208) and displays the analysis to users (step 209).

In one novel embodiment of this invention, the client operations are accomplished using standard function contained within a set-top box that supports the ATVEF standard.

In one standard implementation of ATVEF, “triggers” flow in the VBI of a video stream, typically in line 21. Triggers are real-time events delivered for the enhanced TV program, and always include URLs. When a set-top box encounters such triggers, the set-top box executes the trigger.

One type of trigger causes the set-top box to attempt to automatically load the web page associated with the URL included in the trigger. By exploiting this function together with a novel use of a web server, the objects of this invention can be accomplished with little change to existing infrastructure.

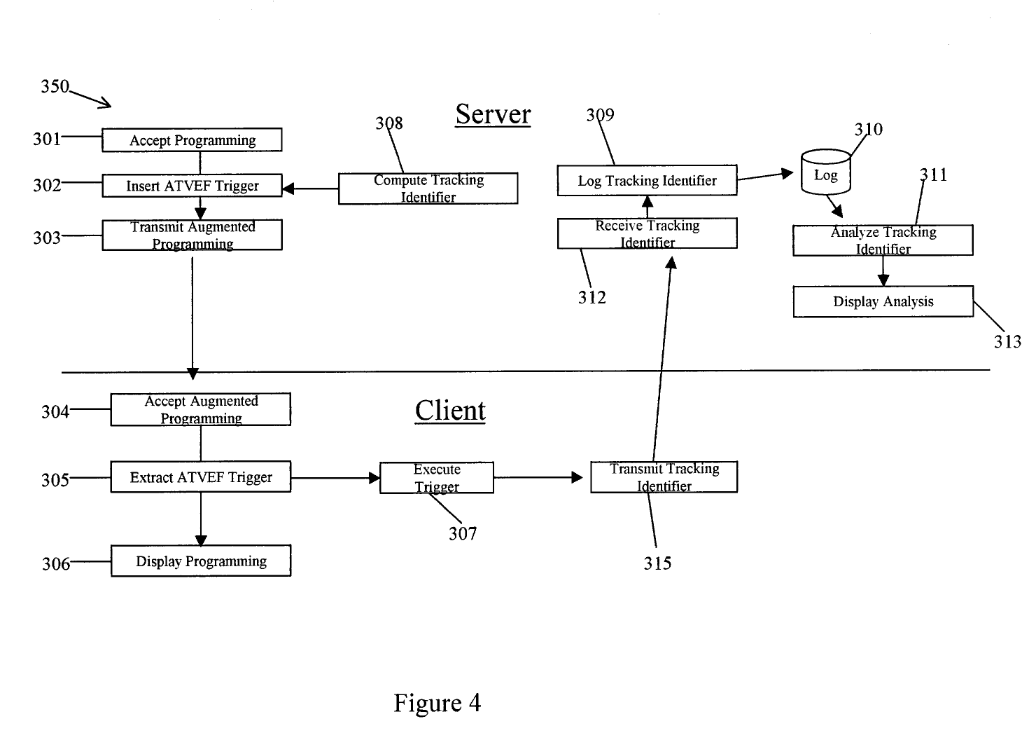

FIG. 4 illustrates this process. In greater detail, information, typically television programming, is received by the server (step 301). Typically this programming is encoded using the NTSC standard that specifies a VBI. A tracking identifier, typically unique, is computed (step 308). In one embodiment, the tracking identifier includes a unique integer computing by incrementing a counter. The tracking identifier is inserted into the programming (step 302). In this embodiment, the tracking identifier, including the computed integer, is inserted as a trigger comprising a URL according to the ATVEF standard. The augmented programming is then transmitted to the client (step 303).

A set-top box implementing the ATVEF standard and housing the client accepts the augmented programming (step 304). According the standard behavior of an ATVEF implementation, the ATVEF trigger is extracted (step 305), and according to an optional implementation component of the ATVEF standard, the trigger is executed automatically (step 307). By executing the trigger, the client requests the web page specified by the URL comprising the trigger, thus transmitting the tracking identifier (step 315). For example, such a URL might be of the form: http://<servername>/<tracking identifier>. The remainder of the programming is then displayed to the user (step 306).

At the server, a web server is executing, and receives the tracking identifier carried within the URL associated with the requested web page (step 312) and logs that request, including the tracking identifier to the web servers log file (step 309).

It is immaterial whether the web server contains content to satisfy the request for the web page, so it is assumed that the web server returns a “file not found” indicator to the client. It is further assumed that the client ignores this indicator. The web server could choose to return an alternate indicator, or no indicator at all, and the client can choose to perform an alternate operation upon receiving such an indicator (or no indicator) without materially effecting this invention.

The information is available as a series of logged web-page requests (URLs in a log file) for analysis (step 311), and that analysis can be displayed to a user (step 313).

In summary, in this embodiment of the invention, using standard ATVEF-compliant client functions and standard web server operations, much of this invention can be accomplished through novel use of existing components. This is one unique advantage of this invention.

Note that because FIG. 1, FIG. 3 and FIG. 4 are block diagrams, the enumerated items are shown as individual elements. In actual implementations of the invention, however, they may be inseparable components of other electronic devices such as a digital computer. Thus, many of the actions described above may be implemented in software that may be embodied in an article of manufacture that includes a program storage medium.

From the foregoing, it will be appreciated that the methods provided by the invention afford a simple and effective way to track information such as television broadcasts transmitted across a network. The problem designing and implementing userdependent systems is largely eliminated.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes which come within the meaning and range of equivalency of the claims are therefore intended to be embraced therein.

We claim:

1) A method for measuring access patterns of content transmitted from a server to a client said method comprising the steps of:
A) Transmitting at said server content containing a tracking identifier identifying the content;
B) Receiving at said client said content containing said tracking identifier;
C) In response to receiving said content at said client, extracting from said content said tracking identifier; and
D) transmitting from said client to said server said tracking identifier:

2) The method of claim 1 where the tracking identifier comprises a URL.

3) The method of claim 1 where the content is a television broadcast, and said tracking identifier is encoded in said content's VBI.

4) The method of claim 3 where said tracking identifier comprises a URL.

5) The method of claim 1 in which said content is digital.

6) The method of claim 1 in which said content is analog.

7) The method of claim 1 in which said content is received from an information provider.

8) The method of claim 1 in which said client transmits to said server auxiliary information along with said tracking identifier.

9) The method of claim 8 in which said auxiliary information includes at least one of: identification of viewer and geographic location.

10) The method of claim 1 in which said client also displays said information to a viewer.

11) The method of claim 1 further comprising:
A) Receiving at said server said tracking identifier.
B) Recording at said server said tracking identifier.

12) The method of claim 11 further comprising the steps of:
A) Recording auxiliary information at said server.

13) The method of claim 12 in which said auxiliary information comprises at least one of time of day and date.

14) The method of claim 3 in which said tracking identifier is encoded in the VBI according to the ATVEF standard.

15) The method of claim 1 in which said tracking identifier is an industry standard code.

16) The method of claim 15 in which said industry standard code is defined by the AAAA.

17) The method of claim 1 in which said content is an advertisement and said tracking identifier comprises an ISCI code.

18) The method of claim 1 in which said client constructs URL comprising the tracking identifier and transmits said URL to said server.

19) The method of claim 18 in which said server comprise a web server.

20) The method of claim 19 in which said web server receives from said client said URL comprising the tracking identifier.

21) The method of claim 20 in which, in response to said receipt of said URL from said client, said web server record said URL comprising said tracking identifier.

22) The method of claim 21 in which said web server records said URL in said web server's log file.

23) A system for measuring access patterns of content transmitted from a server to a client comprising the steps of:
A) Transmitting at said server content containing a tracking identifier identifying the content;
B) Receiving at said client said content containing said tracking identifier;
C) In response to receiving said content at said client, extracting from said content said tracking identifier; and
D) Transmitting from said client to said server said tracking identifier.

24) The system of claim 23 where the tracking identifier comprises a URL.

25) The system of claim 23 where the content is a television broadcast, and said tracking identifier is encoded in said content's VBI.

26) The system of claim 25 where said tracking identifier comprises a URL.

27) The system of claim 23 in which said content is digital.

28) The system of claim 23 in which said content is analog.

29) The system of claim 23 in which said content is received from an information provider.

30) The system of claim 23 in which said client transmits to said server auxiliary information along with said tracking identifier.

31) The system of claim 30 in which said auxiliary information includes at least one of: identification of viewer and geographic location.

32) The system of claim 23 in which said client also displays said information to a viewer.

33) The system of claim 23 further comprising:
A) Receiving at said server said tracking identifier.
B) Recording at said server said tracking identifier.

34) The system of claim 33 further comprising the steps of:
A) Recording auxiliary information at said server.

35) The system of claim 34 in which said auxiliary information comprises at least one of time of day and date.

36) The system of claim 25 in which said tracking identifier is encoded in the VBI according to the ATVEF standard.

37) The system of claim 23 in which said tracking identifier is an industry standard code.

38) The system of claim 37 in which said industry standard code is defined by the American Association of Advertising Agencies.

39) The system of claim 23 in which said content is an advertisement and said tracking identifier comprises an ISCI code.

40) The system of claim 23 in which said client constructs URL comprising the tracking identifier and transmits said URL to said server.

41) The system of claim 40 in which said server comprise a web server.

42) The system of claim 41 in which said web server receives from said client said URL comprising the tracking identifier.

43) The system of claim 42 in which, in response to said receipt of said URL from said client, said web server record said URL comprising said tracking identifier.

44) The system of claim 43 in which said web server records said URL in said web server's log file.

45) A computer program for measuring access patterns of content transmitted from a server to a client comprising:
A) Computer executable program code means for transmitting at said server content containing a tracking identifier identifying the content;
B) Computer executable program code means for receiving at said client said content containing said tracking identifier;
C) Computer executable program code means for, in response to receiving said content at said client, extracting from said content said tracking identifier; and
D) Computer executable program code means for transmitting from said client to said server said tracking identifier.

46) A computer program as described in claim 45 further comprising:
A) Computer executable program code means for receiving at said server said tracking identifier.
B) Computer executable program code means for recording at said server said tracking identifier.
